(19) United States
(12) Patent Application Publication
(10) Pub. No.: US 2013/0248047 A1
(43) Pub. Date: Sep. 26, 2013

(54) ROTARY FLUID DISPENSER

(71) Applicant: Claudio Dordoni, Parma (IT)

(72) Inventor: Claudio Dordoni, Parma (IT)

(73) Assignee: GEA PROCOMAC S.P.A., Sala Baganza (PR) (IT)

(21) Appl. No.: 13/991,048

(22) PCT Filed: Mar. 30, 2012
(86) PCT No.: PCT/IB2012/051572

§ 371 Date: May 31, 2013

(30) Foreign Application Priority Data
May 2, 2011 (IT) PR2011A000033

(51) Int. Cl. B65B 3/22; B67C 3/00

(52) U.S. Cl. CPC B67C 3/225
USPC 141/69; 222/478; 141/242; 141/145

(57) ABSTRACT

A rotary fluid dispenser, comprising: at least a fixed portion (3) provided with an arched window (5) developing from a first end (A) to a second end (B); at least a rotary portion (4) rotating about a predefined axis (x) bearing a plurality of fluid dispensing outlets (6); a treatment zone having an arched development, which is contained in the arched window (5) and extends from a fixed start point (C) to an end point (B) determined by the second end of the window (5); means (9) for varying the initial angular position of the arched window (5) with respect to the pre-defined axis (X) in such a way as to vary the extension of the treatment zone.

### TECHNICAL FIELD AND BACKGROUND ART

The present invention relates to a rotary fluid dispenser, in particular for use in the bottling industry. The fluid to be dispensed can have different functions: for example it may be a beverage to be bottled or a sanitisation fluid for containers or preforms.

A rotary dispenser for a filler is already known from document DE202006000325, which dispenser comprises a fixed portion and a rotary portion that are coaxial and superposed. The fluid to be dispensed passes through channels formed centrally in the fixed portion and the rotary portion. To prevent loosening due to aging and wear, an adjustable tensioning element is interposed between the fixed portion and the rotary portion.

Document EP2070865 discloses a rotary dispenser equipped with sensors able to detect physical properties of the seal element of the fluid conveyor line such as to signal any leaks and risks of contamination associated with the line. The rotary dispenser can be used for filling containers with a beverage or for dispensing sterilising fluid, including in a gaseous form.

Further examples of rotary dispensers for dispensing beverages to a plurality of containers are disclosed in documents US2010/0037986 and U.S. Pat. No. 7,409,808.

In order to avoid unnecessary waste of the sterilant, it must be ensured that the fluid is being dispensed over all the angular transit extension of the containers, while the fluid flow is interrupted at the part known as the “dead angle” at which the containers do not transit. Rotary dispensers are already known that are equipped with appropriate valves, actuated mechanically or pneumatically, capable of blocking the dispensing of the fluid at the dead angle.

However, the use of these valves has a significant effect on the overall costs of the rotary dispenser, in addition to requiring periodic maintenance by specialized personnel.

There also exist dragging manifolds in which one of the elements in contact is provided with an arched through-opening (or slot) which allows dispensing of fluid only to a predefined angular zone of treatment. The duration of the treatment is fixed since it is determined by the angular range of the slot, which is dimensioned according to the maximum production speed of the machine.

As the speed of production of the machine in case of format change has to be varied, the duration of the treatment also varies since the angular width of the slot is fixed. For example, if the machine is to operate at a lower rated velocity with a format, treatment duration increases. In fact, the fluid dispenser nozzles take longer to travel along the slot.

On the other hand, the duration of the sterilization of the preforms with hot hydrogen peroxide steam cannot exceed a predetermined threshold, so that damage to the plastic material is avoided, which would render the preforms unfit for blow molding.

In this context, the technical task underpinning the present invention is to disclose a rotary fluid dispenser which overcomes the drawbacks of the prior art mentioned above.

### DISCLOSURE OF THE INVENTION

In particular, an object of the present invention is to provide a rotary fluid dispenser in which the dispensing duration is adjustable according to the format of the containers.

A further object of the present invention is to provide a rotary fluid dispenser that is constructionally simple and easy to maintain.

The specified technical and the set aims are substantially achieved by a rotary fluid dispenser comprising the technical characteristics set forth in one or more of the appended claims.

### BRIEF DESCRIPTION OF DRAWINGS

Further characteristics and advantages of the present invention will more fully emerge from the non-limiting description that follows of a preferred but not exclusive embodiment of a rotary fluid dispenser, as illustrated in the accompanying drawings in which:

FIG. 1 illustrates a first embodiment of a rotary fluid dispenser according to the present invention, in a simplified section view (some parts have been removed for reasons of clarity);

FIG. 2 illustrates the rotary fluid dispenser of FIG. 1, in perspective view from above;

FIGS. 3 and 4 show a detail (fixed portion) of the rotary dispenser of FIG. 1, with an arched window in two different initial angular positions, in a view from above;

FIG. 5 illustrates a second embodiment of the rotary fluid dispenser, in a perspective view;

FIG. 6 illustrates the rotary fluid dispenser of FIG. 5, in a section view;

FIG. 7 shows the rotary fluid dispenser of FIG. 5, in an exploded view.

### BEST MODE FOR CARRYING OUT THE INVENTION.

With reference to the figures, reference numeral 1 denotes a rotary fluid dispenser originating from a supply line. For example, the disclosed rotary dispenser 1 is used to dispense a liquid beverage to a plurality of containers. Alternatively, the rotary dispenser 1 dispenses a sterilization fluid (liquid or gaseous) to containers or preforms.

The rotary dispenser 1 comprises at least a fixed portion 3 and at least a rotary portion 4 that rotates about a predefined axis X.

The fixed portion 3 is provided with an arched window 5 (or slot) which develops from a first end A to a second end B. In particular, the angular development of the arched window 5 is less than 340°. Preferably, the angle of development is between 180° and 340°.

The rotary portion 4 bears a plurality of dispensing outlets 6 of the fluid coming from the supply line. The rotary dispenser 1 preferably comprises a plurality of taps (not shown). For example, a tap or a plurality of taps is associated to each outlet 6. Each tap is configurable between an open condition in which the fluid is dispensed, and a closed condition in which the dispensing of the fluid is interrupted.

The containers (or preforms) receive the fluid at a treatment zone contained in the arched window 5, and also having an arcuate development. In particular, the treatment zone extends from a starting point C fixed to an end point B determined by the second end of the arched window 5.

Originally, the rotary dispenser 1 comprises means 9 for varying the initial angular position of the arched window 5 with respect to the predefined axis X such as to vary the extension of the treatment zone. By initial angular position is meant the position assumed by the arched window 5 with respect to the predefined axis X before the rotary dispenser 1 commences operation.

The fixed portion 3 is secured to a stationary base 10 bearing the supply line. The means 9 for varying the initial angular position of the arched window 5 with respect to predefined angle X comprise screws 13 and slots 14 for fastening the fixed portion 3 to the base 10.

Compensation springs (not illustrated) are located inside the rotary dispenser 1, which springs press the base 10 onto the fixed portion 3, and then onto the rotary portion 4, thus maintaining them in contact.

The fastening screws 12 of the rotary dispenser 1 are loosened to adjust the initial angular position of the arched window 5.

By loosening the above-mentioned fastening screws 12, the load exerted by the compensation springs is reduced and by loosening also the screws 13 of the means 9 for varying the initial angular position, the rotary portion is disengaged from the parts with which it is in contact and can rotate around the predefined axis X, thus enabling the angular position of the arched window 5 to be modified.

The rotary portion 4 is provided with an angular reference system (not illustrated) in order to enable fine adjustment of the initial angular position of the arched window 5.

By tightening the above-mentioned screws 12, 13, the arched window 5 is secured in the desired initial angular position.

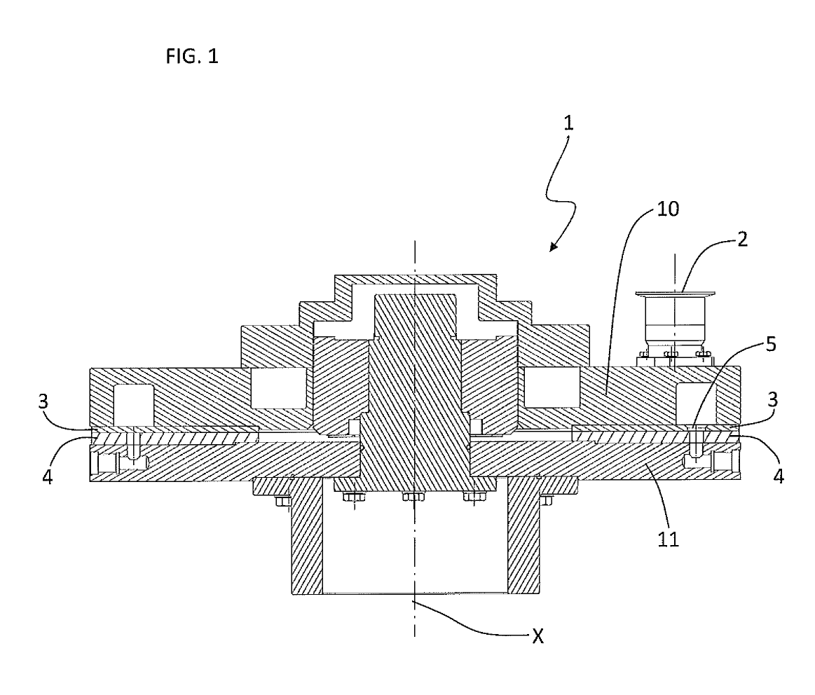

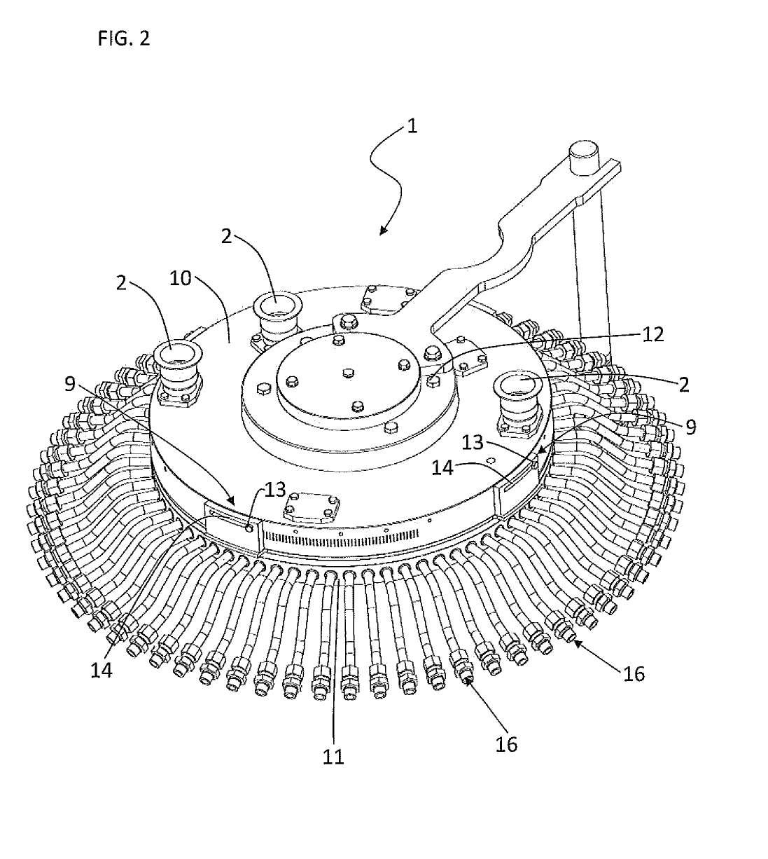

In a first embodiment, illustrated in FIGS. 1 to 4, the fixed portion 3 and the rotary portion 4 are constituted respectively by a first disc 3 and by a second disc 4. The arched window 5 consists of a through-opening that passes from base to base of the first disc 3. The outlets 6 consist of holes afforded in the second disc 4.

The first disc 3 (fixed) is arranged above and in contact with the second disc 4 (rotary). The stationary base 10 is formed by a third disc placed above and in contact with the first disc 3 (fixed). The stationary base 10 bears a plurality of conduits 2 that branch off from the supply line (not illustrated).

A fourth rotary disc 11 is located below and in contact with the second disc 4 (rotary). Dispensing tubes 16 connected to outputs 6 depart from the fourth disc 11.

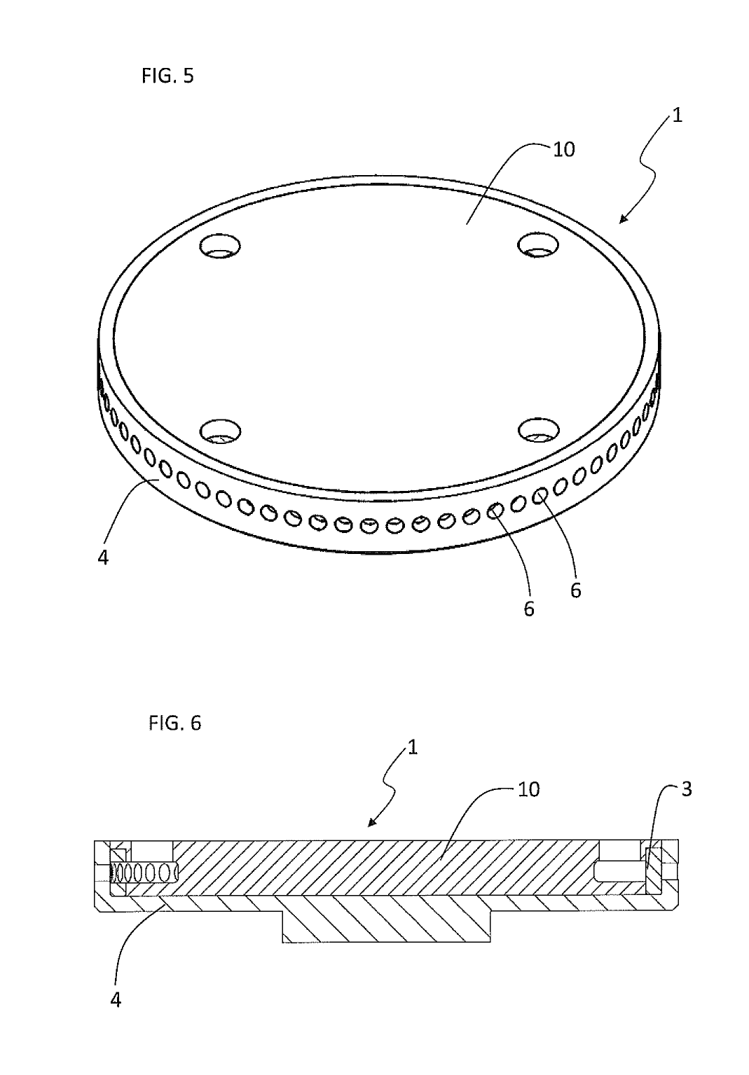

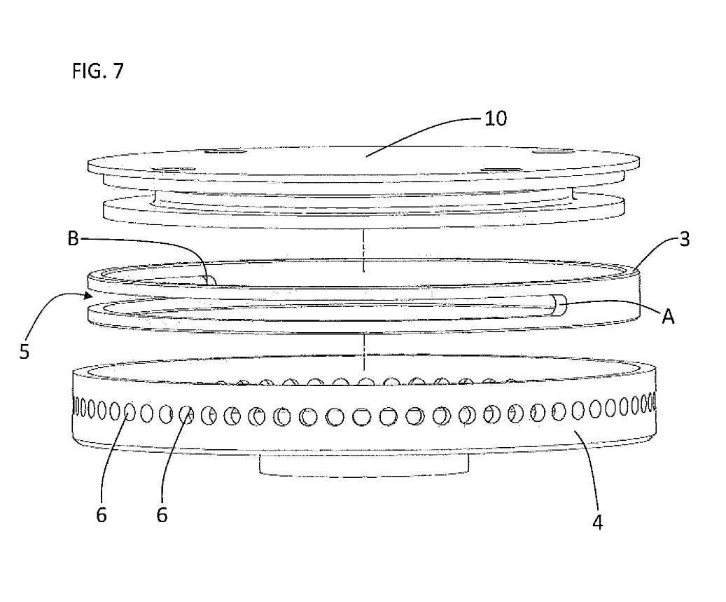

In a second embodiment, illustrated in FIGS. 5 to 7, the fixed portion 3 and the rotary portion 4 are concentric and coaxial. In particular, the fixed portion is shaped as a hollow cylinder having a lateral surface crossed from side to side by the arched window 5. The hollow cylinder 3 surrounds and is in contact with the base 10.

Also the rotary portion 4 has the form of a hollow cylinder, the lateral surface of which is provided with holes 6 constituting the fluid-dispensing outlets. The operation of the rotary fluid dispenser of the present invention is described below with reference to the first embodiment.

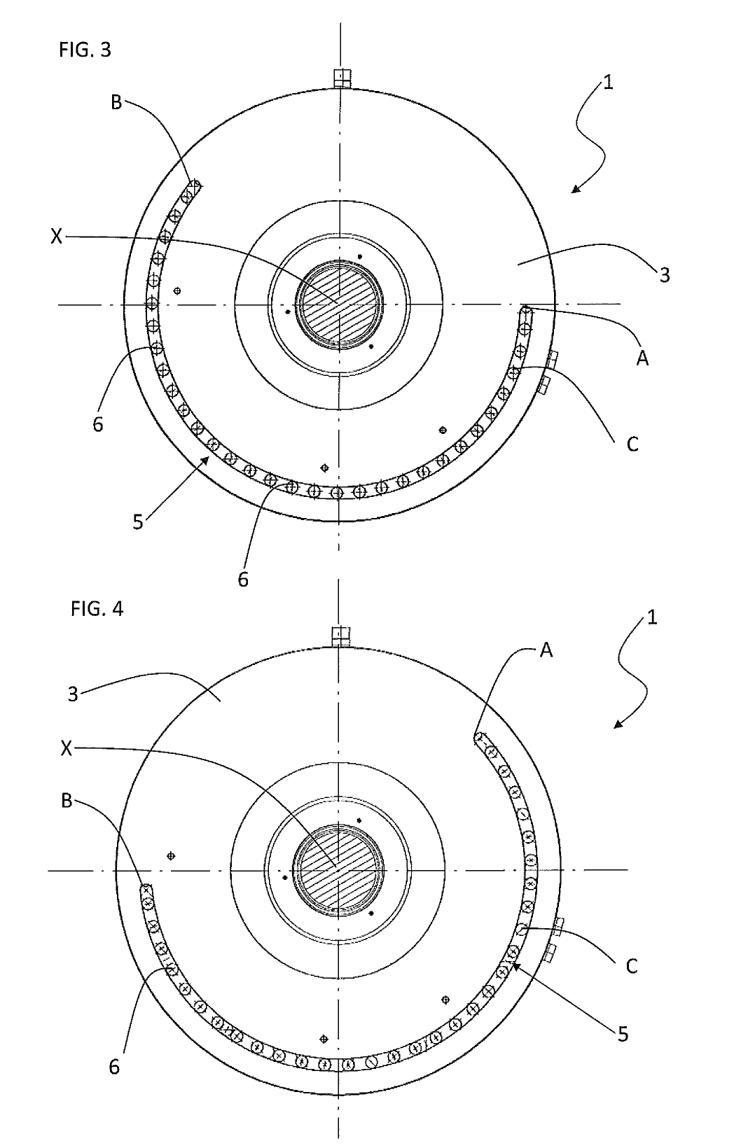

Firstly, as already explained herein above, the initial angular position of the arched window 5 is set with respect to the predefined arched axis X, which is maintained fixed during the operation of the rotary dispenser 1 (see for example FIG. 3).

The rotary portion 4 then begins to rotate about the axis X, reaching a predefined operating speed such that the outlets 6 periodically intercept the treatment zone. Thanks to a cam mechanism, when each tap reaches the initial point C of the treatment zone it passes from the closed condition to the open condition, thus beginning to deliver the fluid. It continues to dispense up to the end point B of the treatment zone, i.e. the second end B of the arched window 5. In other words, given the working rotation velocity of the rotary portion 4, the duration of the dispensing is fixed by the extension of the treatment zone.

Should it be necessary to vary the duration of the dispensing time, it is necessary to adjust the initial angular position of the arched window 5 with respect to the predefined axis X by regulating the screws 13 and the fastening slots 14. In so doing, the angular position of the first end A and the angular position of the second end B of the arched window 5 are changed. Since the initial point C of the treatment zone is fixed (in fact is determined by the cam mechanism), while the end point B follows the movement of the arched window 5, the result is a modification of the extension of the treatment zone (see FIG. 4).

For example, consider a rotary dispenser 1 with a clockwise rotation direction. If the dispensing period is to be reduced, it is sufficient to retract the arched window 5 in an anticlockwise direction, as illustrated in the sequence of FIGS. 3 and 4.

From the above description the characteristics of the rotary fluid dispenser according to the present invention emerge clearly, as do the advantages it provides.

In particular, the versatility of the disclosed rotary dispenser is ensured by the fact that the period during which dispensing is performed is made to depend on the initial angular position of the arched window (or slot). In this way, the dispensing period is easily adjustable to the format of the containers by simply offsetting the position of the window relative to the rotation axis.

In addition, the described rotary dispenser is constructionally simple and easy to maintain as the adjustment of the dispensing period is achieved with the exclusive use of mechanical systems (no valves are required).

1. A rotary fluid dispenser, comprising:
a fluid supply line;
at least a fixed portion provided with an arched window developing from a first end to a second end;
at least a rotating portion bearing a plurality of dispensing outlets of the fluid coming from the supply line;
a treatment zone having an arched development, which is contained in said arched window and extends from a fixed start point to a final point determined by the second end of the window, said at least a rotating portion rotating about a predefined axis such that the fluid dispensing outlets periodically intercept the treatment zone,
characterised in that it further comprises means for varying the initial angular position of said arched window with respect to the predefined axis in such a way as to vary the extension of the treatment zone.

2. Rotary dispenser according to claim 1, wherein said at least a fixed portion and said at least a rotating portion are constituted respectively by a first disc and a second disc.

3. Rotary dispenser according to claim 2, wherein said first disc is located superiorly of and in contact with said second disc.

4. Rotary dispenser according to claim 2, wherein said arched window consists of an opening passing from a base to another of said first disc.

5. Rotary dispenser according to claim 1, wherein said at least a rotating portion and said at least a fixed portion are concentric and coaxial.

6. Rotary dispenser according to claim 5, wherein said at least a fixed portion has a hollow cylinder shape having a lateral surface crossed from side to side by said arched window and said at least a rotating portion also has a hollow cylinder shape having a lateral surface provided with holes constituting said fluid dispenser outlets.

7. Rotary dispenser according to claim 1, wherein said arched window has an angular development of less than 340°.

8. Rotary dispenser according to claim 7, wherein said arched window has an angular development comprised between 180° and 340°.

9. Rotary dispenser according to claim 1, further comprising a base bearing conduits connected to the supply line, said means for varying the initial angular position of the arched window comprising screws and slots for fastening the fixed portion to the base.

10. Rotary dispenser according to claim 1, further comprising a plurality of taps, each of which is associated to one of said fluid dispensing outlets and is configurable between an open condition in which the fluid is dispensed, and a closed condition in which the dispensing of the fluid is halted, the passage of each tap from the closed condition to the open condition occurring always at the start point of the treatment zone and being determined by a cam mechanism.

11. Rotary dispenser according to claim 3, wherein said arched window consists of an opening passing from a base to another of said first disc.
